(19) United States
(12) Patent Application Publication
(10) Pub. No.: US 2005/0139463 A1
(43) Pub. Date: Jun. 30, 2005

(54) Gaseous fuel production from aqueous slurry of carbon-rich feedstock

(76) Inventor: Charles A. McClure, Lexington, VA (US)

Correspondence Address: Charles A. McClure, P.O. Box 1369, Lexington, VA, 24450, US

(21) Appl. No.: 10/839,902

(22) Filed: May 6, 2004

Related U.S. Application Data
(63) Continuation-in-part of application No. 10/750,393, filed on Dec. 31, 2003.

(51) Int. Cl. B01J 19/08; B01J 19/12

(52) U.S. Cl. 204/164; 422/186.04

(57) ABSTRACT

Production of non-self-combustible gaseous product, combustible with added air or other oxygen source, by electric-arc processing of water-slurried fragmented carbonaceous feedstock (e.g., anthracite ore, or graphite ore, or carbon-rich residue) within an appropriate high-temperature reactor defining a reaction zone, as by and between spaced-apart high-temperature-resistant electrodes; also methods of compacting and slurrying such feedstock, and passing an electric arc through the compacted fragmented wetted feedstock, thus forming—and subsequently collecting from overhead—desired gaseous product; also apparatus for performing the foregoing steps and obtaining the non-self-combustible gaseous product—whose combustion effluent with added air or equivalent source of gaseous oxygen is substantially free of harmful gases, and also of liquid and/or solid particulates.

This is a continuation-in-part of Ser. No. 10/750,393 filed Dec. 31, 2003.

### TECHNICAL FIELD

This invention concerns conversion of fragmentary carbon-rich feedstock, by electrical arcing, into non-self-combustible gas whose air-combustion effluent is free of noxious gases and particulates.

### BACKGROUND OF THE INVENTION

Underwater arcing of carbon in rod or other continuous form, to generate gaseous fuel, is disclosed in U.S. patents, as by Eldridge: U.S. Pat. No. 603,058; by Dammann: U.S. Pat. Nos. 6,183,608; 5,417,817 [et al.]; and U.S. Pat. No. 5,159,900; by Lee (et al.): U.S. Pat. No. 6,217,713; and by Richardson: U.S. Pat. Nos. 6,299,738 6,299,656 [et al.]; U.S. Pat. Nos. 6,263,838; 6,153,058; 6,113,748; 5,826,548; 5,792,435; 5,692,459; and 5,435,274. Yet such fuel and its production are rare.

### SUMMARY OF THE INVENTION

This invention enables commercially successful production of such environmentally friendly non-self-combustible gaseous fuel by exposing an aqueous slurry of fragmentary carbon-rich feedstock (e.g., anthracite ores, graphite ores, or pre-used carbon residues) to high-temperature electrical-arcing (i.e., plasma) conditions, in a suitable reaction zone, preferably water-flooded, and retrieving the resulting gaseous product, which collects thereabove.

The reactor contains one or more sets of electrodes supplied with adequately high-voltage electricity, whether continuously or intermittently. Individual electrodes conduct simultaneously or in preselected or otherwise timed or random order, as may be preferred.

Fragmented carbon-rich feedstock, is forwarded by a suitable (e.g., helical) conveyor to such reaction zone, where—in aqueous slurry form—it is is further compacted and wetted, then is greatly heated by and between arcing electrodes, preferably composed of tungsten or of one or more alloys thereof noted for durability under plasma-like conditions. The desired gaseous fuel evolves therefrom and collects thereabove, whence it is removed (as by pumping), such as for storage or use on-site or shipment by pipeline, truck, etc.

### SUMMARY OF THE DRAWINGS

FIG. 1A is a block diagram of electrical equipment to implement this invention upon fragmented wetted carbon-rich feedstock; and

FIG. 1B is a block diagram of equivalent process steps thereof.

FIG. 2A is a side elevation, partly sectioned away, of means for conveying fragmented feedstock to a reaction zone in a high-temperature (electrical arcing) reactor of this invention; and

FIG. 2B is a transverse cross-section of such a reaction zone;

FIG. 3A is a front elevation of a multiple-electrode array, such as was shown transversely in FIG. 2B; and

FIG. 3B is a medial longitudinal section of an electrode useful in such a multiple electrode array—and/or similarly useful alone.

### DESCRIPTION OF THE INVENTION

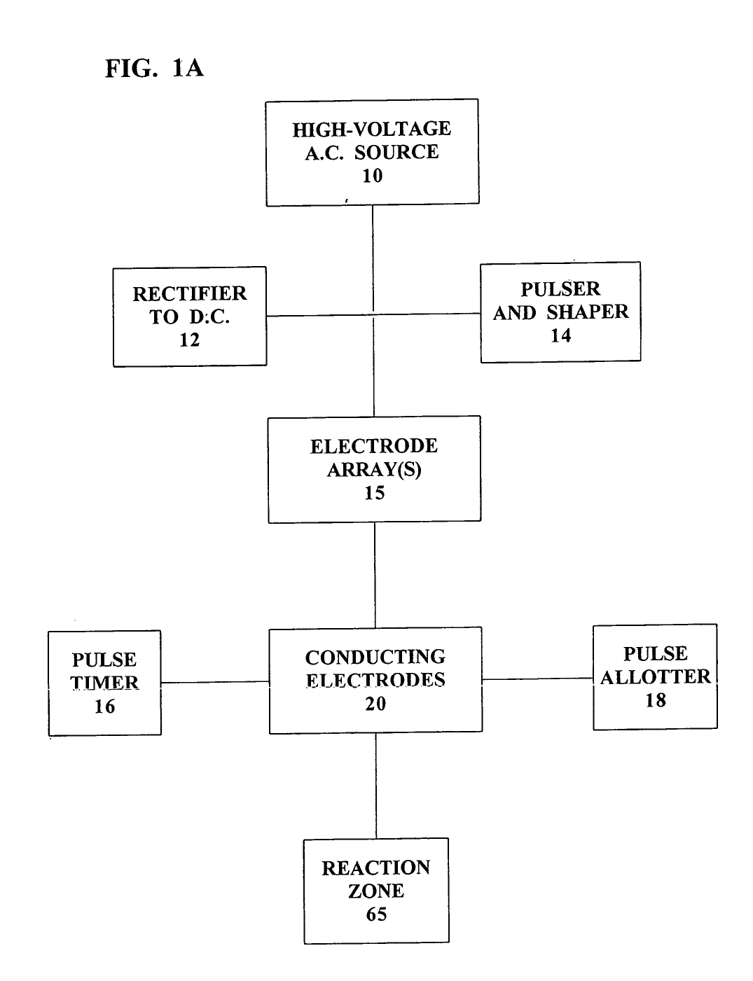

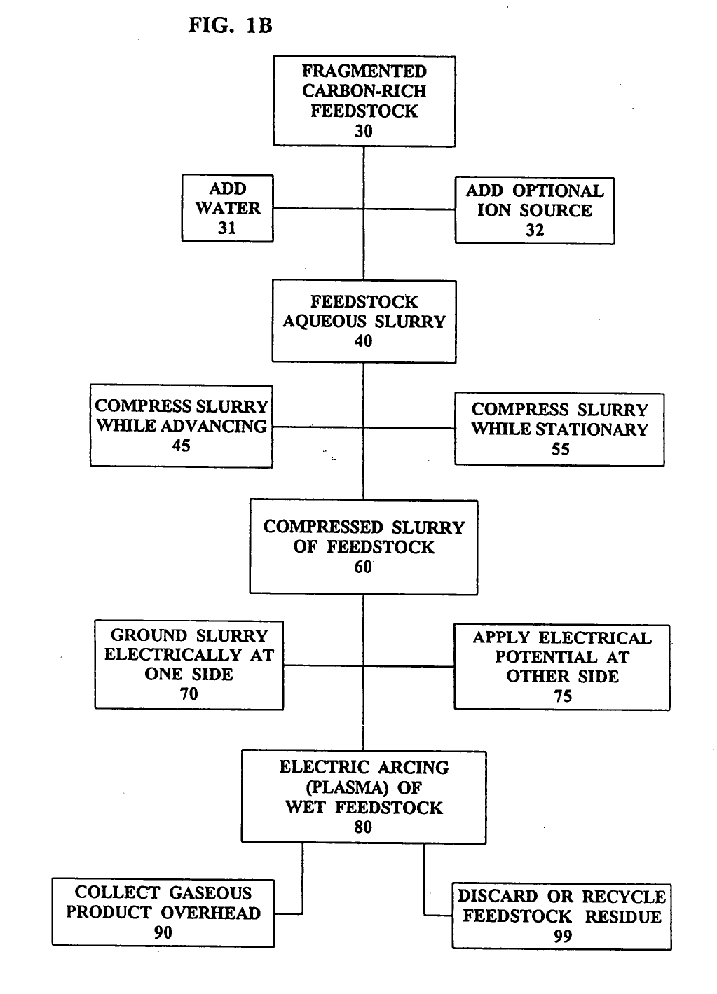

FIG. 1A states (reading downward from the top) that electricity for practicing this invention is readily obtainable, as from an offsite High-Voltage A.C. Source 10 (e.g., a commercial supplier); and that such electricity therefrom or from a similarly suitable source is readily convertible, as by conventional Rectifier to D.C. 12; and that the output therefrom (future input to the subject feedstock) is readily provided, as in intermittent configuration, by Pulser and Shaper 14, on the way to reaching Electrode Array(s) 15.

Pulse Timer 16 and Pulse Allotter 18 enable individual pulses of whatever predetermined size and shape to actuate (i.e., electrify or “fire”) Conducting Electrodes 20, whether at random or according to preselected patterns—whichever may be preferred—in a designated Reaction Zone 65.

FIG. 1B traces (also reading downward) the path of Fragmented Carbon-Rich Feedstock 30 as a related sequence of events: Add Water 31, and—perhaps—Add Optional Ion Source 32 (e.g., acetic acid), resulting in Feedstock Aqueous Slurry 40; then Compress Slurry While Advancing 45 (to the reaction zone), and/or Compress Slurry While Stationary 55 (in that reaction zone).

FIG. 1B steps performed on the resulting Compressed Slurry of Feedstock 60 include Ground Slurry Electrically at One Side 70, and then Apply Electrical Potential at Other Side 75. These steps result in Electric Arcing (plasma) of Wet Feedstock 80.

Formation of the desired gaseous fuel product then ensues, thus enabling as further steps: Collect Gaseous Product Overhead 90, and Discard or Recycle Feedstock Residue 99, as may be pre-timed and/or may result from current human and/or instrumental monitoring.

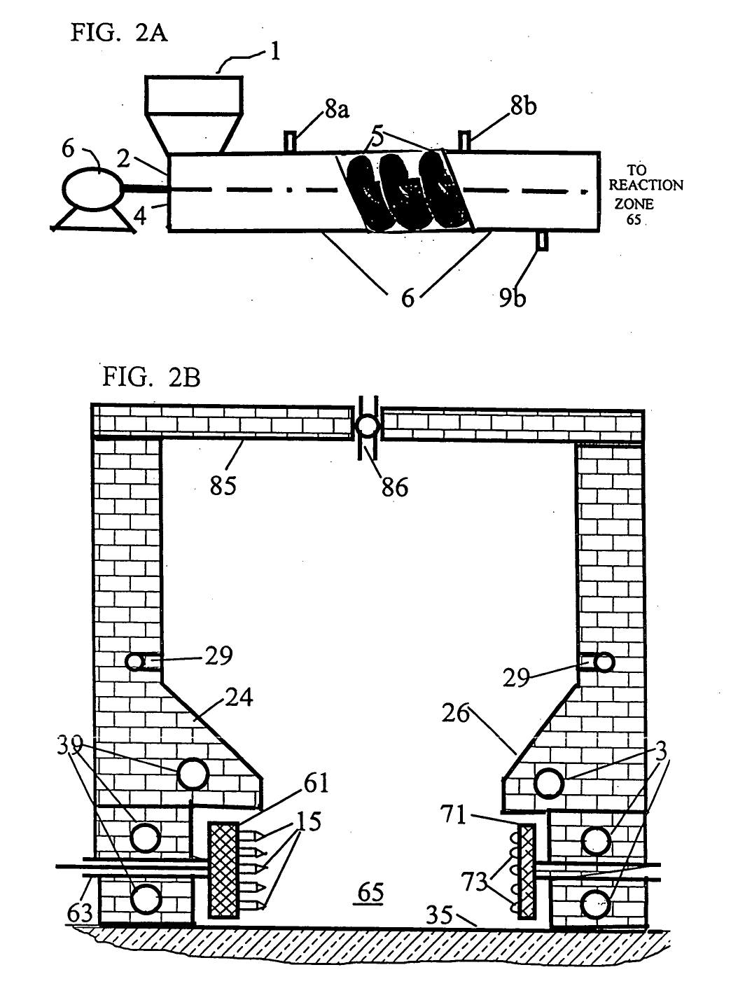

FIG. 2A shows, in side elevation, hopper 1 adapted to receive fragmented feedstock 30 and guide it into the input end of conveyor housing 3—partly sectioned away to reveal forwarding means (auger, helical rotor, or screw) 5 inside. Drive motor 6, at left end of rotor shaft 2, imparts axial rotation to forward the contents.

The fragmented feedstock may enter the hopper wet but usually fairly dry and will be converted to an aqueous slurry 7, as water (piped from an external source not shown) enters the conveyor via any of several adjustable inlets—such as 8a and 8b—spaced along the housing top. One or more similarly adjustable outlets—such as 9—is/are located at intervals along the conveyor underside to preclude excessive slurry fluidity. Rotation of the conveyer screw transports the feedstock slurry to, and discharges it into, such a reaction zone, an example of which is shown next.

For simplicity the conveyor axis is shown as horizontal, but it might slant downward instead, so as to facilitate slurry travel to—and its discharge within—the reaction zone (seen in the next view).

FIG. 2B shows, mainly in transverse section, reaction zone 65 defined between left sidewall 24 and right sidewall 26 flanking—at their bases—floor 35, and rising to ceiling (or other overhead cover) 85, which here contains centrally located outlet valve 86 to enable venting and collection 90 of eventual gaseous product 100.

The reactor walls (shaded here for brick) preferably comprise brick, ceramic, stone, or other high-temperature-resistant material. Furthermore, here they prefeerably contain a network of refrigerant channels 39 connected to an external supply (not shown) to assure the structural integrity of the walls at the exceedingly high temperatures reached during electrical arcing in the reaction zone.

The walls also hold water supply piping, with lateral outlet(s) 29 into reaction zone 65, above sloping wall portions overhanging a pair of alcoves for the respective juxtaposable arcing means when at rest. Such withdrawal of array plates facilitates residue removal and also servesq to protect the electrodes from inadvertent damage.

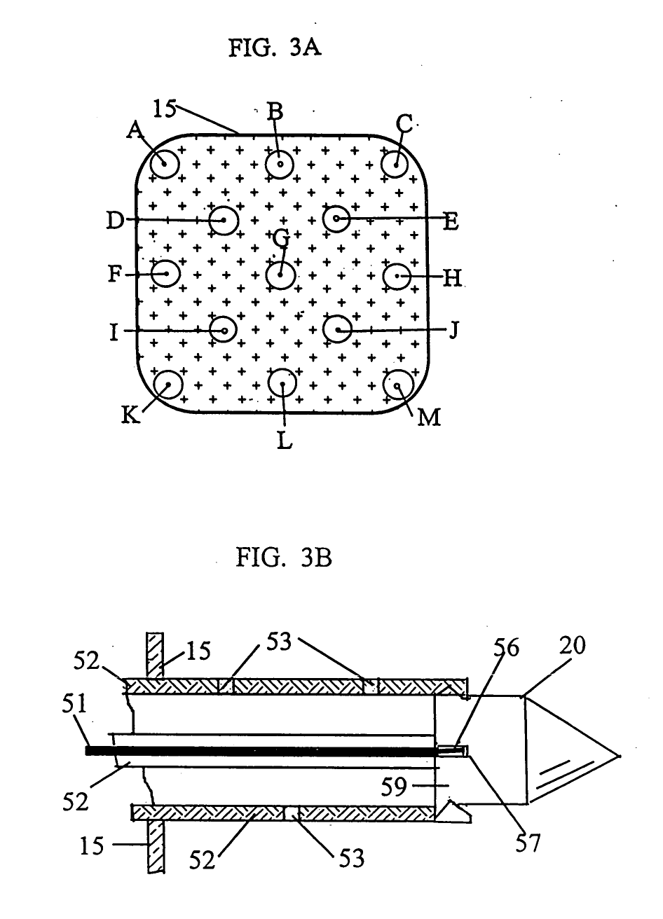

The arcing means comprise upstanding multiple-electrode array plate 61 on hollow horizontal shaft 63 (at the left) and a similar array of electrically conductive nubs 72 on grounding plate 71 on similar shaft 73 (at the right), both at least the former shaft being movable horizontally to and fro by respective external means not shown here. Such mounting enables counterposing of those respective arrays, compressing whatever feedstock is supported therebetween on floor 25, and facilitating the desired electrical arcing. Extending leftward from hollow shaft 63 is electrical conductor cable 62, which connects (not shown here) to a previously mentioned external high-voltage source. Such cable and the internal structure of such an electrode appear in FIG. 3B. Both the electrode tips and the matching juxtaposable grounding nubs are arranged in the form of an extended or expanded version of a familiar domino pattern, as is illustrated and described in the next view.

FIG. 3A shows exemplary multiple-electrode array 15 housing face-on, exhibiting a pattern of thirteen electrodes A . . . to . . . M)—as though the familiar five-spotted domino were extended by adding an outer ring of three spots per edge (each corner being in two rows). Each such electrode is wired individually, to conduct electricity whenever—and so long as—is desired, as mentioned hereinabove.

FIG. 3B shows in longitudinal section, on a much larger scale, a single electrode of the multiple array of FIG. 3A, sectioned lengthwise except at its conical tip 20. Its tubular housing 52 surrounds insulated hot-wire 51, whose bare end 56 seats in indentation 57 in base 59 of conducting conical electrode proper 20, which screws (or snaps) into its surrounding housing end—as suggested by an unshaded tip portion of its housing (at lower right). Outer wall 52 of base tubing 52 has lateral outlets or “weep holes” 53 enabling water outflow therethrough (from an outside source—not shown) into adjacent slurry 60 when in use—as during electrical arcing.

Both shafts are horizontally piston-actuated by conventional means (not shown) for varying interplate spacing, and compression of slurried between-plate feedstock thus facilitating and/or stimulating desired electric arcing in the feedstock therebetween. Related external components—e.g., high-pressure tubing, and fluid cooling, pumping, and storage means—are omitted here as well-known.

Circulation of water into and through the individual electrodes via the hollow supporting shaft for the electrode array plate aids in cooling and stabilizing the electrode tips and also assists in maintaining fluidity of the neighboring feedstock slurry.

During such ensuing electric arcing, the desired fuel gas forms and collects above the water that has flooded the feedstock itself. The fuel can be drawn off readily, as through overhead valved outlet 86, by aid of conventional (preferably oil-free) pumping apparatus.

After cessation of arcing, the respective array plates usually are retracted to their rest positions, in their respective alcoves, and unreacted residue 98 is removed from the reaction zone. Of course, such residue may undergo subsequent re-treatment in the same or another reactor—or may simply undergo some form of disposal 99.

Such removal is readily accomplished, as by sweeping residue back into the forwarding conveyor and reversing the rotation direction of its helical screw, thus converting it into an exit conveyor. Such disposal thereof may be accomplished by humans who enter the reaction zone via a door (not shown) in a side or end wall and/or by equivalent mechanical pushing or sweeping means.

Refragmenting and/or re-slurrying whatever feedstock residue is left after cessation of arcing may facilitate its removal, whether by personnel or machinery, and whether for re-treatment or disposal.

In the foregoing and/or equivalent arrangement(s), the resultant electrical arcing through the compressed flooded fragmented feedstock yields the desired non-self-combustible gaseous product, itself readily recoverable thereabove, as already noted, whether for immediate or future use, on-site or elsewhere. The gas itself, duly protected from contact with air or equivalent oxygen source, is quite stable and is readily and safely distributable to other user sites, as by pipeline, train, truck, or equivalent transport.

Notwithstanding this description of exemplary embodiments of the present invention, useful modifications may be made in its structuring and/or operation—such as by adding, combining, deleting, or subdividing apparatus, compositions, parts, or steps—while retaining all or most of the advantages and benefits of this invention, which itself is defined most succintly in the appended claims.

1. Method of converting fragmented, predominantly carbon, feedstock and water, within a given high-temperature reaction zone, into non-self-combustible gaseous form—readily combustible with added air, or equivalent source of oxygen, into substantially only non-polluting combustion effluents—comprising the following steps:
(a) situating an aqueous slurry of such feedstock within such reaction zone; and
(b) subjecting such feedstock slurry to electric arcing within the reaction zone; and
(c) collecting non-self-combustible gaseous product emanating therefrom—such product having the aforementioned characteristics.

2. Method according to claim 1, including a step of slurrying such feedstock, by addition of water thereto, while transporting the same to the reaction zone.

3. Method according to claim 1, including a step of adding enough water to the feedstock while within the reaction zone to flood (i.e., submerge) the same.

4. Method according to claim 3, wherein the addition of water submerges (i.e., floods) the feedstock slurry in the reaction zone.

5. Method according to claim 4, including the further step of collecting gaseous product overhead while the zone is so flooded.

6. Method according to claim 1, including the step of siting mutually facing high-voltage and grounding electrodes, controllably movable—both toward and apart from—one another in the zone.

7. Method according to claim 6, including the steps of providing an array of such high-voltage electrodes and a similar array of grounding electrodes, spaced apart facing one another, then reducing the space therebetween, thereby compressing intervening feedstock slurry, until the occurrence of electric arcing therebetween, and finally moving them apart from one another for docking in respective rest positions after electric arcing has been terminated.

8. In a reaction zone for preparation of gaseous fuel by electric arcing within a slurry of fragmented high-carbon feedstock, the apparatus combination of an electrode plate having at least one high-voltage electrode extending therefrom, and a parallel grounding plate having at least one grounded electrode (or “nub”) extending toward the high-voltage electrode, at least one of such plates being controllably movable toward the other to juxtapose, and movable away therefrom from to space apart, the respective plates and electrodes.

9. The apparatus of claim 8, wherein each electrode plate has a plurality of electrodes extending toward a like plurality of electrodes on the other plate, the respective electrodes on each plate being juxtaposable to opposing electrodes on the other plate by horizontal movement of at least one plate toward the other plate.

10. The apparatus of claim 9, wherein the respective plates are oriented substantially vertical, and their respective electrodes are oriented substantially horizontal and located similarly thereon.

11. The apparatus of claim 10, wherein the electrodes of the respective plates are adapted to approach their counterparts on the other plate closely enough for electrical arcing therebetween.

12. Reactor means for practicing the method of claim 1, itself comprising a high-temperature reaction zone containing an array of high-voltage electrodes, and a facing array of grounded electrodes, plus means adapted (a) to move at least one array so as to juxtapose the respective arrays and so compress feedstock slurry therebetween, and (b) to effectuate electric arcing within such feedstock slurry, and then (c) to space the arrays apart in non-arcing rest positions.

13. Reactor means adapted to convert within a defined reaction zone fragmentary carbon feedstock and water into a fuel gas (itself non-self-combustible, but combustible with later added gaseous oxygen), comprising laterally spaced walls of high-temperature-resistant material, also having the following physical features:
a. piping for refrigerant circulating throughout the walls of the reaction zone, thus enabling those walls to retain structural integrity at very high temperatures reached by electrical arcing;
b. in-wall piping means effective to circulate water to the reaction zone and adapted to release it onto such feedstock therein;
c. between-walls juxtaposable plates effective to compact wetted feedstock for exposure to subsequent electrical arcing; and
d. opposable electrodes upon such respective plates effective to provide electrical arcing treatment of wetted feedstock compacted therebetween—thereby converting carbon-rich feedstock and adjacent water into such non-self-combustible gaseous product (whose air-combustion effluent is substantially free of noxious gases, and also similarly free of liquid particulates and of solid particulates).

14. Reactor means according to claim 13, wherein such between-walls compacting means is adapted to move horizontally within the reaction zone, against feedstock to be converted therein, along with water, into gaseous fuel, to compress the feedstock therebetween,

15. Reactor means according to claim 14, wherein such between-walls means comprises a pair of electrode-carrying plates, one with at least one electrode for high-voltage electricity, and one with at least one juxtaposable electrically grounded electrode (or “nub”).

16. Reactor means according to claim 15, wherein at least one of such between-walls electrode-carrying plates is adapted to move horizontally within the reaction zone, and including means to effect such movement to juxtapose at least one electrode of one such plate to an aligned electrode of the other such plate, thereby enabling electrical arcing within intervening water and carbon-rich feedstock and consequent conversion thereof into the desired fuel.

17. Non-self-combustible gas, combustible with addition of air or other source of gaseous oxygen, resulting from electrical arcing within the intervening water and feedstock in the reactor means of claim 16, having been collected and stored for future combustion.
